(19) United States
(12) Patent Application Publication
(10) Pub. No.: US 2014/0281300 A1
(43) Pub. Date: Sep. 18, 2014

(54) Opportunistic Tier in Hierarchical Storage

(71) Applicant: Silicon Graphics International Corp., Milpitas, CA (US)

(72) Inventor: Charles Robert Martin, Superior, CO (US)

(73) Assignee: Silicon Graphics International Corp., Milpitas, CA (US)

(21) Appl. No.: 13/831,694

(22) Filed: Mar. 15, 2013

(51) Int. Cl. G06F 3/06

(52) U.S. Cl. CPC G06F 3/0647; G06F 3/0604; G06F 3/0683
USPC 711/161

(57) ABSTRACT

A system reduces the impact of constrained bandwidth to long-term data storage without adding new data storage resources to the data center, typically by temporarily storing data on data storage devices that are contained within a desktop computer, a notebook computer, or other computing device. The invention stores lower priority data sets temporarily on data storage devices that are already purchased or expensed until lower priority data sets can be migrated to long-term data storage. The invention relieves the performance impact of congestion caused by slow communication interfaces, recording channels, and mechanical systems that move tape cartridges around. The invention may also be configured with security functions that restrict where or how certain data sets are stored temporarily.

### BACKGROUND OF THE INVENTION

1. Field of the Invention

The present invention generally relates to data storage systems. More specifically, the present invention relates to storing low priority data on storage systems external to a data center.

2. Description of the Related Art

The modern data center contains a plurality of heterogeneous types of data storage equipment wherein data are stored in what are referred to as “tiers”, conventionally each tier is referred to by number, such as tier 0, tier 1, tier 2, and tier 3, with lower number tiers usually referring to more expensive and relatively fast data storage media and locations offering lower latency data access to the data processing computer resources, while higher number tiers are typically less expensive but higher-latency data storage. In today's data center tier 0 typically consists of random access memory, tier 1 consists of solid state disks, tier 2 consists of solid state disk drives or fast disk drives, and tier 3 consists of slower disk drives or tape.

Conventionally higher priority data sets are files that are accessed more frequently, and are stored on faster more costly data storage devices to improve performance and response times. They therefore are associated with having a higher value than medium or lower priority data sets. Thus, data sets that are accessed “rarely” are considered to be less valued and are typically migrated to long-term data storage resources.

The process of migrating lower priority data sets to long-term data storage is itself a slow process. Frequently the ability of the data center to migrate lower priority data sets to long-term data storage is constrained or bottlenecked. Limited data communication bandwidth to long-term data storage devices reduces the overall performance of the data center. This is because higher speed data storage resources have the capacity to send data faster than the long-term data storage devices can receive and store the data. Simply put, the ability to migrate lower priority data sets to long-term data storage is limited by: slow long-term data storage data communication interfaces; slow recording channels; and slow mechanical systems that move, mount, and demount tape cartridges in tape drives.

Various systems have been employed to reduce the impact of constrained bandwidth to long-term data storage resources. Typically, these solutions involve adding more disk drives in the data center. Sometimes these additional disk drives are configured as virtual tape. Virtual tape appears to the data center as a very fast and responsive tape drive. Virtual tape subsystems initially store data on an array of disk drives and then migrate that data to tape. Unfortunately, adding disk drives or virtual tape subsystems to the data center is expensive to purchase, house, and to power.

What is needed is a way to reduce bottlenecks encountered because of constrained bandwidth to long-term data storage resources.

### SUMMARY OF THE CLAIMED INVENTION

The invention stores data on data storage systems outside the typical data center storage devices. As a result, the invention reduces the impact of constrained bandwidth to long-term data storage without adding new data storage resources to the data center. The present system may store data on alternative data storage devices that are contained within a desktop computer, a notebook computer, or other computing device, for example those computer devices utilized by employees of the enterprise customer for whom the data is stored. The invention stores lower priority data sets temporarily on the alternative data storage devices that have already been purchased or expensed, thereby providing a storage means a little or no incremental cost, until lower priority data sets can be migrated to long-term data storage. The invention relieves the performance impact of congestion caused by slow communication interfaces, recording channels, and mechanical systems that move tape cartridges around.

A method or system consistent with the invention first identifies lower priority data sets that should be migrated to long-term data storage. Next, the system identifies underutilized data storage device resources external to the data center. The underutilized data storage device should be such that data may be stored at the devices temporarily. Low priority data sets may then be assigned by targeting particular underutilized data storage resources external to the data center Lower priority data sets may then be moved to assigned underutilized data storage resources external to the data center, and then those data sets may be migrated to long-term data storage at a later time.

Certain embodiments of the invention move lower priority data sets though a computer network to data storage devices contained within desktop computers, notebook computers, or other computing devices that are outside of the conventional boundaries of the data center. Such data storage devices that are targeted to receive lower priority data sets are referred to in this disclosure as a “target storage location” or “target storage locations”. Since the invention targets data storage devices have unused space that is available to store data, and since these data storage devices are resources that are located outside of the convention physical boundaries of the data center, these data storage devices are referred to as being “underutilized external data resources”.

Certain other embodiments of the invention identify more than one underutilized data storage target to which any particular data set may be stored temporarily. The invention may thus have redundancy built into some embodiments.

The invention stores lower priority data temporarily on data storage devices that are already purchased or expensed instead of purchasing new data storage devices or subsystems. At appropriate times, when long-term data storage resources have available bandwidth, lower priority data sets are migrated from underutilized external data resources to long-term data storage.

Frequently data sets are files. Embodiments of the invention are not, however limited to treating files as the only form of data sets. Data sets may also include snapshots of network activity, records of changes to files, or other forms of information tracked in the data center for which a persistent record is targeted for long-term storage. The invention thus creates a new data storage tier that is located outside of the boundaries of the data center in its conventional sense.

### BRIEF DESCRIPTION OF THE DRAWINGS

FIG. 1 illustrates various storage elements utilized for storage of data, which are located inside and outside a data center.

FIG. 2 illustrates a simplified block diagram of a data center compute resource.

FIG. 3 is a flow diagram illustrating program flow in an embodiment of the invention.

FIG. 4 illustrates an embodiment of the invention that supports a plurality of different security levels and functions.

### DETAILED DESCRIPTION

The invention includes a system and method that reduces the impact of constrained bandwidth to long-term data storage without adding new data storage resources to the data center, typically by temporarily storing data on data storage devices that are contained within a desktop computer, a notebook computer, or other computing device. The invention stores lower priority data sets temporarily on data storage devices that have already been purchased or expensed, thereby providing a storage means at a little or no incremental cost, until lower priority data sets can be migrated to long-term data storage. The invention relieves the performance impact of congestion caused by slow communication interfaces, recording channels, and mechanical systems that move tape cartridges around.

Embodiments of the invention may include a method or system that identifies lower priority data sets that should be migrated to long-term data storage, identifies underutilized data storage resources that are external to the physical boundaries of the data center to which data may be stored temporarily, assigns particular low priority data sets by targeting particular underutilized external data storage resources, moves lower priority data sets to assigned underutilized external data storage resources, and then migrates those data sets to long-term data storage at a later time.

FIG. 1 illustrates various storage elements utilized for storage of data, which are located inside and outside a data center. The data center may be configured to communicate with various computers located external to the physical boundaries of the data center. FIG. 1 depicts a Data Center 101 with a plurality of internal elements including a plurality of Compute resources 102, a plurality of solid state drives (SSDs) 103, a plurality of slower disk drives 104, a plurality of tape drives 105, Network Adaptors 106, and a wireless network antenna 107. Wired network cables 108 connect the Data Center's 101 Network Adaptors 106 to a plurality of Desktop Computers 109 that are outside of the Data Center 101. Notebook Computers with wireless network antennas 110 are also depicted outside of the Data Center 101, and may communicate with the data center via one or more wireless protocols.

The external storage devices, desktop computers 109 and notebook computers 110, may store low priority data as the external storage devices have room. For example, if the computers used by data center employees have disk drive memory that is not being utilized, low priority data may be temporarily stored on the employee disk drive. Many factors may be taken into consideration when determining when and where to store low priority data on an external computer, including ownership and identification of the computer, history of memory storage usage by the computer, type of employee having access to the computer, and other factors.

FIG. 2 illustrates a simplified block diagram of a data center compute resource. The data center compute resource 201 of FIG. 2 may implement the compute resources in data center 101 of FIG. 1. Compute resource 201 includes Microcomputer 202 in communication with Random Access Memory 203, a Solid State Disk 204, and a Local Area Network 205. Such compute resources are standard in the art, and are sometimes are referred to as compute nodes. Essentially, they are high-speed computers that include some memory and a communication pathway to communicate with other resources in the data center, including other data center compute devices or data storage resources.

FIG. 3 is a flow diagram illustrating program flow in an embodiment of the invention. The flowchart of FIG. 3 begins with one or more lower priority data sets being identified at step 301. For example, data may be identified as low priority if the data is older than a particular date, is associated with a particular user or project, or meets some other criteria associated with a low priority. The flow chart then continues to step 302 where underutilized external data storage devices are identified and assigned as targets for storing lower priority data. Underutilized external data may include employee computers, laptop computers within range of one or more data center wireless networks, and other devices that have data storage bandwidth and are suitable for storing data.

Lower priority data sets may be moved to underutilized external data storage targets at step 303. In some embodiments, the migration may occur during times of low usage of the underutilized targets. The migration may occur to underutilized targets from data center storage or other underutilized targets. Finally, lower priority data located on external data storage devices may be migrated to long-term data storage at step 304. The data may be migrated when the long-term storage data becomes available. The order of the migration may be in order of priority of the data stored on the underutilized targets.

The invention creates a new data storage tier that is located outside of the boundaries of the data center in its conventional sense. Some embodiments of the invention move lower priority data sets though a computer network to targeted data storage resources, opportunistically. Such targeted data storage resources are herein defined to include spaces outside of the physical boundaries of the conventional data center.

A significant embodiment of such underutilized, off reservation data storage resources are data storage devices that are contained within a desktop computer, a notebook computer, or other computing device that is, at least at some points in time, connected to a computer network capable of communicating with the data center.

Certain other embodiments of the invention identify and associate more than one underutilized data storage targets located outside of the data center to which any particular data set may be stored temporarily. Such embodiments of the invention thus are configured to contain lower priority data sets redundantly. Such targets include yet are not limited to the plurality of computers 209 with wired network connections, and computers with wireless network antennas 210 shown in FIG. 2.

In non-redundant embodiments of the invention, lower priority data sets may not be accessible by the data center whenever any particular computer storing them is turned off or disconnected from the computer network. This accessibility issue may also occur in redundant embodiments of the invention if more than one computer were powered down or disconnected from the computer network. The invention will typically track such events and migrate the lower priority data stored in underutilized data storage targets to long-term data storage sometime after they re-appear on the network.

A plurality of different security levels may be incorporated into embodiments of the invention. Security levels, for example, may relate to a priority wherein data sets above a certain level or of a certain class may be sent to target stores that are associated with a greater likelihood of remaining available, such as desktop computers within the data center that are always or usually powered on, where data sets at other levels could be sent to any available target store, such as lap top computers that are powered on intermittently. Other examples of security level usage consistent with certain embodiments of the invention include yet are not limited to: a first security level relating to redundancy wherein data will be migrated to more than one target; a second security level wherein certain lower priority data sets are moved to targets that are not mobile; a third security level wherein certain lower priority data sets are moved only to computers that are in certain physical locations. Thus security levels could correspond to a level of security, or be encrypted. In yet other embodiments a plurality of priority levels could encompass a plurality of security levels.

FIG. 4 illustrates an embodiment of the invention that supports a plurality of different security levels or functions. The embodiment of the invention depicted in FIG. 4 first decodes and maps a priority to an associated security 401. Eight different security levels are shown in the figure, parameters mapped to in box 401 relate to: redundancy, encryption, and stationary data storage devices only. The security levels illustrated in FIG. 4 are illustrated for exemplary purposes, and are not intended to be limiting.

Each parameter maps to a bit that can have a value of a 0 or a 1, since there are 3 bits there are a total of 8 security levels that are possible described in FIG. 4: Redundancy, No Encryption, Non-Stationary data storage devices acceptable 402: Redundancy, Encryption, Stationary data storage devices only 403: No Redundancy, No Encryption, Stationary data storage devices only 404: No Redundancy, No Encryption, Non-Stationary data storage devices acceptable 405: Redundancy, Encryption, Non-Stationary data storage devices acceptable 406: No Redundancy, Encryption, Stationary data storage devices only 407: No Redundancy, No Encryption, Non-Stationary 408: and No Redundancy, No Encryption, and Non-Stationary data storage devices acceptable 409.

The flow chart in FIG. 4 then continues to step 410 where underutilized external data storage devices are identified as targets for storing lower priority data. Next, lower priority data sets are moved to external underutilized data storage devices that were identified and assigned as targets at step 411. Finally, lower priority data located on external data storage devices are migrated to long-term data storage at step 142.

Since embodiments of the invention stores lower priority data temporarily on data storage devices that may be already purchased or expensed, vast amounts of capital expenses may be saved without reducing the performance of the data center. Instead of purchasing expensive new disk drives or virtual tape subsystems, data storage devices that are already owned fill the data storage gap without reducing overall data center performance. Thanks to high speed modern wired networks such as multi-gigabit Ethernet connecting desktop computers, and high speed wireless networks such as 802.11, underutilized data storage resources contained outside of the data center are predominantly faster than the combined delays inherent in long-term data storage resources. This is because the new networking technologies are faster than the combined latencies of slow data communication interfaces, slow recording channels, and slow actuation systems for moving tape cartridges around.

The above description is illustrative and not restrictive. Many variations of the invention will become apparent to those of skill in the art upon review of this disclosure. While the present invention has been described in connection with a variety of embodiments, these descriptions are not intended to limit the scope of the invention to the particular forms set forth herein. To the contrary, the present descriptions are intended to cover alternatives, modifications, and equivalents as may be included within the spirit and scope of the invention as defined by the appended claims and otherwise appreciated by one of ordinary skill in the art

What is claimed is:

1. A method for managing lower priority data comprising:
identifying a low priority data set;
identifying underutilized data storage resources external to data center storage;
storing the low priority data set in the underutilized data storage external to the data center storage resource for a first period of time; and
migrating the low priority data set from the underutilized data storage external to longer term storage.

2. The method of claim 1, wherein storing the low priority data includes:
assigning the underutilized external data storage resources as a first target to receive the at least one low priority data set; and
moving the at least one low priority data set to the first target.

3. The method of claim 1 further comprising:
assigning a second of the underutilized external data storage resources as a second target to receive for the at least one low priority data set; and
moving the at least one low priority data set to the first target and to the second target.

4. The method of claim 2, further comprising migrating the at least one low priority data set from the first target to long-term data storage.

5. The method of claim 2, further comprising migrating the at least one low priority data set from the first target or from the second target to long-term data storage.

6. A method for managing low priority data, comprising:
identifying at least one low priority data set;
identifying underutilized external data storage resources;
identifying and assigning a security level with the at least one low priority data set wherein the security level indicates restrictions on where or how the at least one low priority data set may be stored on the underutilized external data storage resources;
assigning at least one of the underutilized external data storage resources as a first target to receive the at least one low priority data set; and
moving the at least one low priority data set to the first target.

7. The method of claim 6, further comprising:
assigning a second of the underutilized external data storage resources as a second target to receive the at least one low priority data set; and
moving the at least one low priority data set to the second target.

8. The method of claim 6, further comprising migrating the at least one low priority data set from the first target to long-term data storage.

9. The method of claim 7, further comprising migrating the at least one low priority data set from the first target or from the second target to long-term data storage.

10. The method of claim 6, wherein the security level restricts the low priority data set from being stored on the underutilized external data storage resources that are contained within mobile computers.

11. The method of claim 6, wherein the security level restricts the low priority data set to be stored on the underutilized external data storage resources in an encrypted format.

12. A system for managing low priority data, comprising:
a processor;
a memory;
one or more modules stored in memory and executable by a processor to:
identify at least one low priority data set;
identify underutilized external data storage resources; and
assign at least one of the underutilized external data storage resources as a first target to receive the at least one low priority data set;

13. The system of claim 12, the one or more modules further executable to move the at least one low priority data set to the first target.

14. The system of claim 12, the one or more modules further executable to:
assign a second of the underutilized external data storage resources as a second target to receive the at least one low priority data set; and
move the at least one low priority data set to the second target.

15. The system of claim 14, the one or more modules further executable to migrate the at least one of the low priority data set from the first target to long-term data storage.

16. The system of claim 14, the one or more modules further executable to migrate the at least one low priority data set from the first target or from the second target to long-term data storage.
